(19) United States
(12) Patent Application Publication
(10) Pub. No.: US 2008/0121114 A1
(43) Pub. Date: May 29, 2008

(54) Control For A Heater

(75) Inventors: John J. Ryan, Independence, KY (US); Ronald R. Weiss, Okeana, OH (US)

Correspondence Address: WOOD, HERRON & EVANS, LLP, 2700 CAREW TOWER, 441 VINE STREET, CINCINNATI, OH, 45202, US

(73) Assignee: GOLD MEDAL PRODUCTS COMPANY, Cincinnati, OH (US)

(21) Appl. No.: 11/564,597

(22) Filed: Nov. 29, 2006

(51) Int. Cl. A23G 3/10

(52) U.S. Cl. 99/331; 425/9; 219/162

(57) ABSTRACT

A heater control for a cotton candy machine automatically controls a heater within the spinner head of the machine to readily accommodate for fluctuations in input line frequency and input line voltage. The control is configured to measure the input line frequency and apply a predetermined voltage to the heater that varies as a function of the measured input line frequency. The control is further configured to measure the input line voltage and apply a generally constant predetermined voltage to the heater for a particular measured input line frequency.

### FIELD OF THE INVENTION

The present invention relates generally to cotton candy machines, and more particularly, to a control for controlling a heater in the spinner head of the cotton candy machine.

### BACKGROUND OF THE INVENTION

A cotton candy machine operates to heat sugar and to cast or spin molten sugar through centrifugal force in fiber or strand form into a tub where it may be gathered on a stick or rolled paper tube for service and consumption. In order to carry out the heating and spinning function, a typical cotton candy machine includes a spinner head with a defined chamber for receiving raw sugar poured into the chamber. An annular slotted spinner band surrounds the chamber and a heater is located in thermal contact with the spinner band. The spinner head imparts a centrifugal force to the raw sugar poured into the spinner head and forces it outwardly against the heater. The heater melts the sugar before it is spun in strand form through the slotted band.

The heat generated by the heater is controlled by the application of voltage to the heater. Preferably, the heat is controlled in a range hot enough to melt the sugar but not so hot as to burn the sugar. With some cotton candy machines, the speed of the rotation of the spinner head in the cotton candy machine may be generally proportional to the input line frequency supplied to the machine. As the frequency decreases, so does the RPM of the spinner head. The spinning of the spinner head provides a fan effect and generally cools the heater during the production of cotton candy. With a drop in the input line frequency, the spinner head spins slower, thereby providing less of the cooling effect. Also, less cotton candy product passes through the slotted band so less heat is carried away by the spun cotton candy. As a result, the temperature of the heater in the spinner head increases the temperature of the head and the potential for burning the sugar exists. Likewise, as the input line frequency increases, so does the RPM of the spinner head and more cooling is experienced by the heater due to the increased fan effect and greater production of cotton candy passing through the slotted band. The increased RPM of the spinner head may result in a drop of the temperature in the spinner head, potentially to a point lower than the melting point of the sugar.

In addition to variations in input line frequency, there may also be variations in input line voltages. These variations are inherent to the environment where cotton candy machines are typically used. For example, cotton candy machines maybe located at a fair or a carnival where power may be supplied by a generator and/or the cotton candy machine is connected to a power source over a long extension cord. Changes in the line frequency may be due to the start of a carnival ride or other draw down on the generator. A voltage drop may occur over the extended length of the extension cord as well as other drops resulting from the start of various equipment.

Temperature of the heater may be generally proportional to the input line voltage. As the input line voltage increases, the temperature of the heater increases and likewise as the voltage decreases, the temperature decreases. Long time operators of cotton candy machines have developed a feel for the proper temperature of the heater and have traditionally manually adjusted the heater temperature, based on feel and instinct developed over many years of use of the machine.

What is needed in the art, therefore, is a cotton candy machine that readily accommodates for fluctuations in input line frequency and input line voltage to consistently produce cotton candy.

### SUMMARY OF THE INVENTION

The present invention overcomes the foregoing and other shortcomings and drawbacks of heater controls for cotton candy machines heretofore known. While the invention will be described in connection with certain embodiments, it will be understood that the invention is not limited to these embodiments. On the contrary, the invention includes all alternatives, modifications and equivalents as may be included within the spirit and scope of the present invention.

The invention addresses these and other problems associated with known cotton candy heater controls by providing a control that is configured to automatically adjust the voltage applied to the heater in the spinner head, and thus control the temperature of the heater, in response to fluctuations in input line voltage and/or input line frequency.

According to one aspect of the present invention, the cotton candy machine is connected to a power source having an input line frequency and an input line voltage. The cotton candy machine includes a heater control that is connected to the input power line and is configured to measure the input line frequency and the input line voltage. The heater control supplies an appropriate voltage to the heater of the spinner head as a function of the input line frequency and the input line voltage. As the input line frequency increases, the voltage applied to the heater is increased to accommodate for the increased fan effect caused by the increased RPM of the spinner head and the greater production of cotton candy passing through the slotted band. Conversely, the voltage applied to the heater of the spinner head is decreased as the input line frequency is decreased to accommodate for a reduction in the RPM of the spinner head.

According to another aspect of the present invention, the heater control provides a generally constant output voltage to the heater of the spinner head at a particular input line frequency while the input line voltage may fluctuate. The input line voltage is measured and reduced to a predetermined lower voltage for a particular input line frequency which is then applied to the heater. In this way, the heater control of the present invention automatically maintains a proper temperature of the heater even while the input line frequency and/or input line voltage fluctuates as may be found in typical cotton candy production environments.

These and other objects and advantages of the present invention will be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, server to explain the principles of the invention.

FIG. 1 is a perspective view of an exemplary cotton candy machine;

FIG. 2 is a cross sectional view of an exemplary spinner head for use with the cotton candy machine of FIG. 1;

FIG. 3 is a functional block diagram of an exemplary heater control for controlling a heater within the spinner head of the cotton candy machine shown in FIG. 1;

FIG. 4 is a flow diagram showing an exemplary operation of the heater control in FIG. 3;

FIG. 5A is a flow diagram showing an exemplary method of determining an output voltage for the heater control shown in FIG. 3; and

FIG. 5B is a flow diagram showing an alternate method of determining an output voltage for the heater control in FIG. 3.

### DETAILED DESCRIPTION OF THE PREFERRED EMBODIMENTS

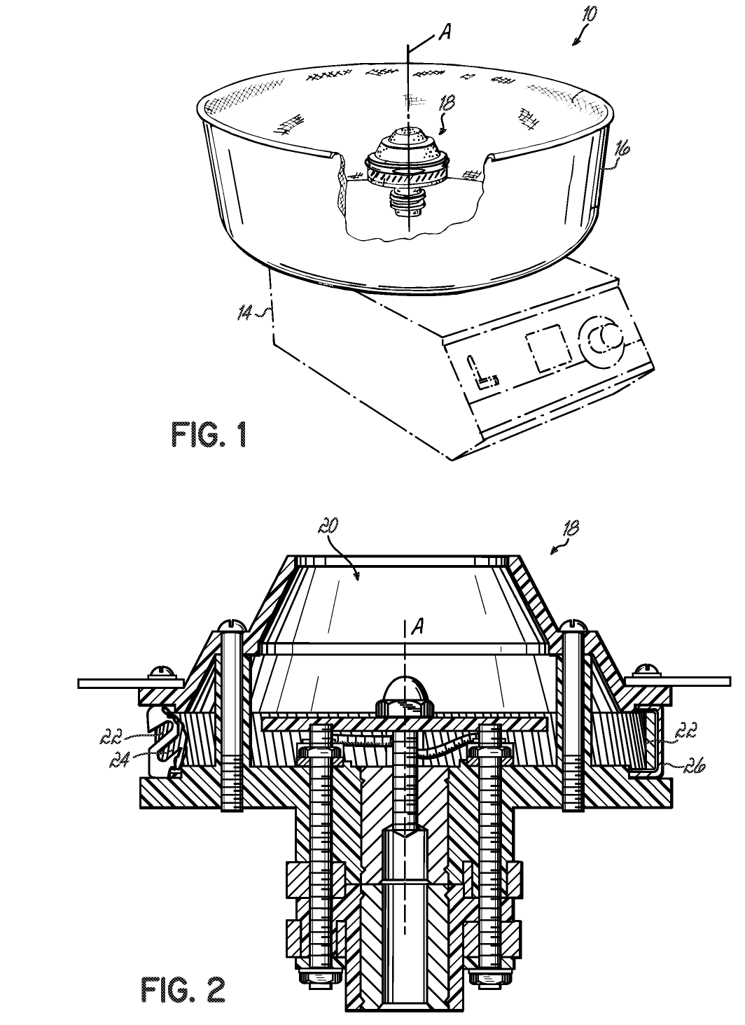

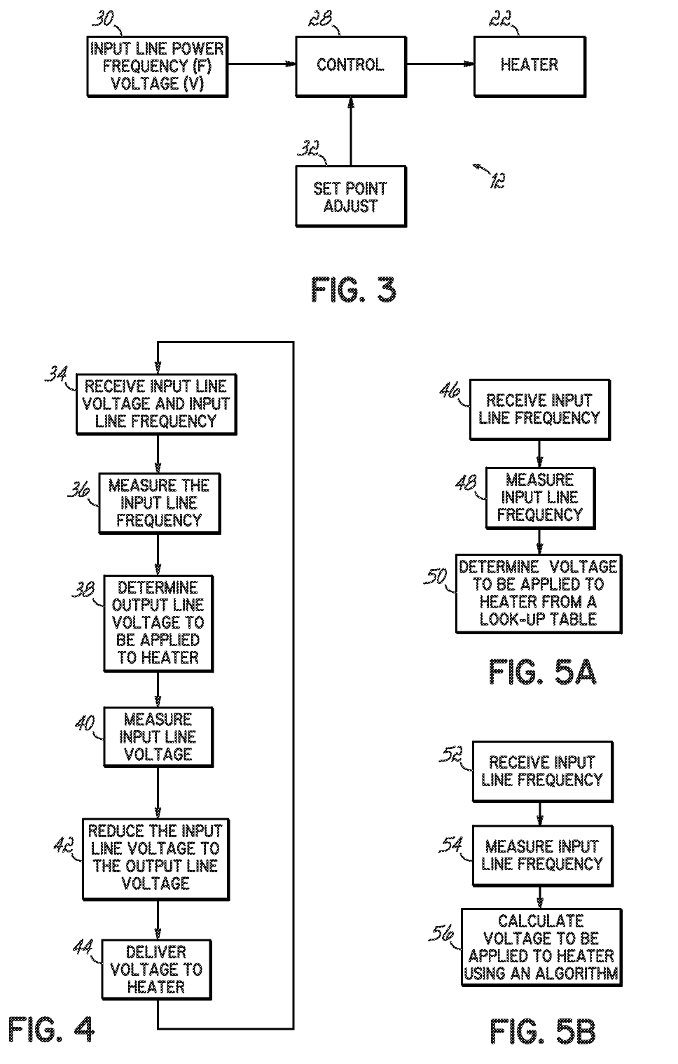

Turning to the drawings, wherein like numbers denote like parts throughout the several views, FIG. 1 illustrates an exemplary cotton candy machine 10 incorporating a heater control 12 (FIG. 3) in accordance with the principles of the present invention. As will be described in greater detail below, the heater control 12 is particularly configured to automatically control heating of the sugar within the cotton candy machine even while the input line frequency and/or input line voltage fluctuates.

The exemplary cotton candy machine 10 shown in FIG. 1 includes a base 14, a bowl or tub 16 into which cotton candy may be spun and a spinner head 18 that is used to melt the sugar and extrude melted sugar filaments which form the cotton candy. In one embodiment as shown in FIG. 2, the spinner head 18 contains a chamber 20 into which raw sugar may be poured. A heater 22 is provided in the spinner head 18 to melt the sugar which is then extruded from slots 24 in a spinner band 26 of the spinner head 18. The spinning motion of the spinner head 18 utilizes centrifugal force created by the spinning motion to move the molten sugar toward the slotted band 26 and extrude sugar filaments out of the spinner head 18 and into the tub 16. In addition to forcing molten sugar from the spinner head 18, the spinning motion also creates a fan cooling effect, which effectively lowers the temperature in the chamber 20. When the cotton candy machine 10 is running at a preferred voltage and frequency, the heater 22 in spinner head 18 is designed to provide sufficient heat to melt the sugar and produce cotton candy of consistent quality.

In one embodiment, the spinner head 18 spins at a rate that is generally proportional to the input line frequency. For example, the spinner head 18 may rotate at about 3,450 RPM when the input line frequency is 60 Hz. As mentioned above, as the input line frequency increases, so does the rotational speed of the spinner head 18. Likewise, as the input line frequency decreases, so does the rotational speed of the spinner head 18. As the RPM of the spinner head 18 is reduced, the cooling from the fan effect is reduced as well as less cotton candy passes through the spinner band 26 to pull away heat. This may cause more residual heat to be present in the chamber 20 than is desired and may cause the sugar to burn without operator intervention. If the RPM of the spinner head 18 increases, the cooling from the fan effect and increased production of cotton candy passing through the spinner head 18 may result in insufficient heat within the spinner head 18 to properly melt the raw sugar. An exemplary relationship between the input line frequency and the RPM of the spinner head 18 is shown by:

| Line Frequency | RPM of Spinner Head |
|---|---|
| 40 Hz | 2300 RPM |
| 50 Hz | 2875 RPM |
| 60 Hz | 3450 RPM |

In one embodiment of the present invention, the heater control 12 (FIG. 3) includes a microprocessor-based control 28 by way of example. The heater control 12 is provided in the cotton candy machine 10 to automatically adjust the voltage applied to the heater 22 in response to fluctuations in the input line frequency and/or input line voltage. In this way, the heater control 12 accurately controls the heater temperature to consistently produce cotton candy even while the input line frequency and/or input line voltage fluctuates.

As shown in FIG. 3, the control 28 has an input that is configured to be electrically coupled to a source of power 30. The source of power 30 has an input line frequency (F) and an input line voltage (V) that each may vary during operation of the cotton candy machine 10. The control 28 has an output that is configured to be electrically coupled to the heater 22 within the spinner head 18 to apply a voltage thereto when the cotton candy machine 10 is operated to produce cotton candy.

A set point adjust 32, such as a variable potentiometer by way of example, may be electrically coupled to the control 28. The set point adjust 32 may be configured to set the output voltage of the control 28 to a predetermined voltage at a particular input line frequency as will be described in greater detail below. Those of ordinary skill in the art will appreciate that the control 28 may not be microprocessor-based in other embodiments and may be implemented in other suitable digital and/or analog hardware. Also, it will also be appreciated that the set point adjust 32 may be implemented in various other ways known to those of ordinary skill in the art and is not limited to a variable potentiometer.

In accordance with one aspect of the present invention, the control 28 is configured to measure the input line frequency and apply a predetermined voltage to the heater 22 that varies as a function of the measured input line frequency. As the input line frequency increases, the voltage applied to the heater 22 is increased to accommodate for the increased fan effect caused by the increased RPM of the spinner head 18 and the greater production of cotton candy passing through the slotted spinner band 26. Conversely, the voltage applied to the heater 22 of the spinner head 18 is decreased as the input line frequency is decreased to accommodate for a reduction in the RPM of the spinner head 18.

In accordance with another aspect of the present invention, the control 28 provides a generally constant output voltage to the heater 22 of the spinner head 18 at a particular input line frequency while the input line voltage may fluctuate. The input line voltage is measured and reduced to a predetermined lower voltage for a particular input line frequency which is then applied to the heater 22. In this way, the heater control 12 of the present invention automatically maintains a proper temperature of the heater 22 by controlling the voltage applied to the heater 22 even while the input line frequency and/or input line voltage fluctuates as may be found in typical cotton candy production environments.

Following is an exemplary table that illustrates the relationship between the input line frequency and the input line voltage at the input of the control 28 and the voltage applied to the heater 22 at the output of the control 28:

| | | Output | Output | Output |
|---|---|---|---|---|
| Input | RMS | Volts | Volts | Volts |
| Line | Input | When | When | When |
| Fre- | Line | Set | set | Set |
| quency | Voltage | Point | Point | Point |
| (Hertz) | (Volts) | Pot = 0 Ohms | Pot = 500 Ohms | Pot = 1000 Ohms |
| 50 | 200 | 85 | 140 | 180 |
| 50 | 210 | 85 | 140 | 180 |
| 50 | 220 | 85 | 140 | 180 |
| 50 | 230 | 85 | 140 | 180 |
| 50 | 240 | 85 | 140 | 180 |
| 50 | 250 | 85 | 140 | 180 |
| 55 | 200 | 90 | 148 | 190 |
| 55 | 210 | 90 | 148 | 190 |
| 55 | 220 | 90 | 148 | 190 |
| 55 | 230 | 90 | 148 | 190 |
| 55 | 240 | 90 | 148 | 190 |
| 55 | 250 | 90 | 148 | 190 |
| 60 | 200 | 95 | 156 | 200 |
| 60 | 210 | 95 | 156 | 200 |
| 60 | 220 | 95 | 156 | 200 |
| 60 | 230 | 95 | 156 | 200 |
| 60 | 240 | 95 | 156 | 200 |
| 60 | 250 | 95 | 156 | 200 |

FIG. 4 shows an exemplary operation of the control 28 to determine and adjust the voltage applied to the heater 22 to maintain a proper sugar melt temperature. At step 34, the control 28 receives the input line frequency and the input line voltage. The input line frequency is measured at step 36 and, at step 38, the control 28 determines a voltage to be applied to the heater 22 as a function of the measured input line frequency. Because the input line voltage is typically greater than the voltage necessary to be applied to the heater 22 to heat the heater to the proper temperature, the control 28 measures the input line voltage at step 40 and reduces that voltage at step 42 to the predetermined voltage corresponding to the measured frequency. The predetermined voltage is then applied to the heater 22 at step 44. This process may be repeated at periodic intervals, such as 2 to 3 times a minute by way of example, thereby minimizing or eliminating the need for the operator to manually adjust the temperature of the heater 22.

FIGS. 5A and 5B illustrate two embodiments for determining the voltage to be applied to the heater 22 as a function of the measured input line frequency. Referring first to FIG. 5A, in one embodiment the control 28 receives the input line frequency at step 46 and measures the input line frequency at step 48. The control 28 may include a look-up table, similar to the table illustrated above by way of example, to determine the voltage to be applied to the heater 22 based upon the measured input line frequency as shown at step 50. In some embodiments, when the measured input line frequency falls between two table values, the nearest table value may be used. In other embodiments, an interpolation of the voltage to be applied to the heater 22 may be calculated from the look-up table and the measured input line frequency.

In another embodiment as illustrated in FIG. 5B, the voltage to be applied to the heater 22 may be determined from an algorithm implemented within the control 28. In this embodiment, the control 28 receives the input line frequency at step 52 and measures the input line frequency at step 54. The control 28 may include an algorithm that calculates the voltage to be applied to the heater 22 based upon the measured input line frequency as shown at step 56. As those of ordinary skill in the art will appreciate, the algorithm may be a simple ratio calculation or may be a more complex curve fit to experimental or empirical data. Of course, other algorithms are possible as well without departing from the spirit and scope of the present invention.

Once the voltage to be applied to the heater 22 has been determined, the heater control 12 must divide the input line voltage into the predetermined voltage to be applied to the heater 22 and an excess voltage. The heater control 12 may use any number of voltage dividing methods and/or hardware including resistors as will be apparent to those skilled in the art. The excess voltage may then be dissipated as heat energy via heat sinks coupled to the heater control (not shown).

The heater control 12 may continuously or periodically monitor both the input line frequency and the input line voltage to determine the voltage to be applied to the heater 22. Based on the environment of a typical cotton candy machine as explained above, fluctuations in both input line frequency and input line voltage may be common. As will be appreciated by those of ordinary skill in the art, the heater control 1 2 of the present invention readily accommodates for fluctuations in input line frequency and input line voltage to consistently produce cotton candy. The heater control 12 of the present invention may also be useful for cotton candy machines that are used in different countries, where power standards are different. For example, once the cotton candy machine is set for operation in the U.S. for a 60 Hz power source, the machine could easily be transported to another country, e.g. Mexico, where there the power source is a 50 Hz source. The heater control 12 would automatically adjust the output voltage for the heater 22 to accommodate for the different line frequency without additional interaction from the operator.

While the present invention has been illustrated by a description of various embodiments and while these embodiments have been described in considerable detail, it is not the intention of the applicant to restrict or in any way limit the scope of the appended claims to such detail. For example, while embodiments for cotton candy machines are illustrated and described herein, the heater control 12 of the present invention may be utilized in other systems or applications that require a predetermined output voltage to be applied in response to fluctuations in input line frequency and input line voltage of a power source. In addition, other advantages and modifications will be readily apparent to those skilled in the art. The invention in its broader aspects is therefore not limited to the specific details, representative apparatus and method, and illustrative examples shown and described. Accordingly, departures may be made from such details without departing from the spirit or scope of Applicants' general inventive concept.

What is claimed is:

1. A heater control for controlling a heater within a spinner head of a cotton candy machine, comprising:
a control having an input configured to be electrically coupled to a source of power including an input line frequency and an input line voltage and an output configured to be electrically coupled to the heater to apply a voltage thereto,
the control being configured to measure the input line frequency and apply a predetermined voltage to the heater that varies as a function of the measured input line frequency.

2. The heater control of claim 1 wherein the control is configured to increase the predetermined voltage applied to the heater as the measured input line frequency increases.

3. The heater control of claim 1 wherein the control is further configured to measure the input line voltage and apply a generally constant predetermined voltage to the heater for a particular measured input line frequency.

4. The heater control of claim 3 wherein the heater control is configured to reduce the measured input line voltage to the generally constant predetermined voltage to be applied to the heater.

5. The heater control of claim 1 further comprising a set point adjust configured to set the predetermined voltage applied to the heater for a particular measured input line frequency.

6. The heater control of claim 1 further comprising a look-up table that defines the predetermined voltage to be applied to the heater for a particular measured input line frequency.

7. The heater control of claim 1 further comprising an algorithm that defines the predetermined voltage to be applied to the heater for a particular measured input line frequency.

8. A heater control for controlling a heater within a spinner head of a cotton candy machine, comprising:
a control having an input configured to be electrically coupled to a source of power including an input line frequency and an input line voltage and an output configured to be electrically coupled to the heater to apply a voltage thereto,
the control being configured to measure the input line frequency and having one of a look-up table and an algorithm that defines a predetermined voltage to be applied to the heater for a particular measured input line frequency; and
a set point adjust configured to set the predetermined voltage applied to the heater for a particular measured input line frequency.

9. A method for controlling a heater within a spinner head of a cotton candy machine with a heater control having an input configured to be electrically coupled to a source of power including an input line frequency and an input line voltage and an output configured to be electrically coupled to the heater to apply a voltage thereto, the method comprising:
measuring the input line frequency with the heater control; and
applying a predetermined voltage to the heater that varies as a function of the measured input line frequency.

10. The method of claim 9 further comprising:
measuring the input line voltage with the heater control; and
applying a generally constant predetermined voltage to the heater for a particular measured input line frequency.

11. The method of claim 10 further comprising:
reducing the measured input line voltage to the generally constant predetermined voltage to be applied to the heater.

12. The method of claim 9 further comprising:
defining the predetermined voltage to be applied to the heater at the output in a look-up table.

13. The method of claim 9 further comprising the step of:
defining the predetermined voltage to be applied to the heater at the output with an algorithm.
